(19) United States
(12) Patent Application Publication
(10) Pub. No.: US 2026/0179274 A1
(43) Pub. Date: Jun. 25, 2026

(54) VISUALIZATION METHOD, VISUALIZATION DEVICE, AND RECORDING MEDIUM

(71) Applicant: NEC Corporation, Minato-ku, Tokyo (JP)

(72) Inventors: Hanae SHIMOMURA, Tokyo (JP); Riki Eto, Tokyo (JP); Dai Kubota, Tokyo (JP)

(73) Assignee: NEC Corporation, Minato-ku, Tokyo (JP)

(21) Appl. No.: 18/702,362

(22) PCT Filed: Mar. 11, 2022
(86) PCT No.: PCT/JP2022/010900

§ 371 Date: Apr. 18, 2024

(51) Int. Cl. G06T 11/26; G06Q 10/10

(52) U.S. Cl. CPC G06T 11/26; G06Q 10/10

(57) ABSTRACT

This visualization device comprises a coefficient acquisition unit and an output control unit. The coefficient acquisition unit acquires, for each of a plurality of different objective functions, a weight coefficient for each of a plurality of feature amounts. The output control unit outputs, in a comparable manner, the acquired weight coefficients for the plurality of objective functions. The weight coefficients for the plurality of feature amounts express the degree of influence of the feature amounts on solutions to the plurality of objective functions.

### TECHNICAL FIELD

The present disclosure relates to a visualization method and the like.

### BACKGROUND ART

In the optimization problem, a function to maximize or minimize a solution under given constraints is called an objective function.

Regarding the machine learning technology, for example, various models such as a logistics regression model, a random forest model, and a tree model can be adopted (see, for example, PTL 1).

For example, there is a technology of learning an objective function based on a decision-making history of a subject (see, for example, PTL 2).

### CITATION LIST

### Patent Literature

PTL 1: JP 2018-010458 A
PTL 2: WO 2021/130916 A1

### SUMMARY OF INVENTION

### Technical Problem

When the objective function is obtained, there is a problem that it is difficult to understand which viewpoint is strongly influenced by the objective function.

An example of the object of the present disclosure is to provide a visualization method and the like for improving ease of checking an objective function.

### Solution to Problem

A visualization method according to an aspect of the present disclosure includes acquiring, for each of a plurality of different objective functions, a weighting coefficient for each of a plurality of feature quantities and outputting the weighting coefficients acquired for the plurality of objective functions in a comparable manner. The plurality of objective functions optimize the same action. The weighting coefficient for each of the plurality of feature quantities indicates a degree of influence of the feature quantity on a solution of each of the plurality of objective functions.

A visualization device according to an aspect of the present disclosure includes a coefficient acquisition means for acquiring, for each of a plurality of different objective functions, a weighting coefficient for each of a plurality of feature quantities and an output control means for outputting the weighting coefficients acquired for the plurality of objective functions in a comparable manner. The plurality of objective functions optimize the same action. The weighting coefficient for each of the plurality of feature quantities indicates a degree of influence of the feature quantity on a solution of each of the plurality of objective functions.

A program according to an aspect of the present disclosure causes a computer to execute processing for acquiring, for each of a plurality of different objective functions, a weighting coefficient for each of a plurality of feature quantities and outputting the weighting coefficients acquired for the plurality of objective functions in a comparable manner. The plurality of objective functions optimize the same action. The weighting coefficient for each of the plurality of feature quantities indicates a degree of influence of the feature quantity on a solution of each of the plurality of objective functions.

The program may be stored in a non-transitory computer-readable recording medium.

### Advantageous Effects of Invention

According to the present disclosure, it is possible to improve ease of checking an objective function.

### BRIEF DESCRIPTION OF DRAWINGS

FIG. 1 is a block diagram illustrating a configuration example of a visualization device according to a first example embodiment.

FIG. 2 is a flowchart illustrating an operation example of the visualization device according to the first example embodiment.

FIG. 3 is a block diagram illustrating a configuration example of a visualization device according to a second example embodiment.

FIG. 4 is an explanatory diagram illustrating an example of a screen on which weighting coefficients of feature quantities in a trade-off relationship are displayed adjacent to each other.

FIG. 5 is a flowchart illustrating Operation Example 1 of a visualization device according to Explanatory Example 1.

FIG. 6 is an example of a screen on which differences between weighting coefficients in a plurality of objective functions are displayed.

FIG. 7 is a flowchart illustrating Operation Example 2 of the visualization device according to Explanatory Example 1.

FIG. 8 is an explanatory diagram illustrating examples of an objective function and a weighting coefficient obtained by a learning case for each skilled person.

FIG. 9 is an explanatory diagram illustrating an example of a screen on which a comparison of weighting coefficients for each objective function and an optimization result of a job assignment for each persona are displayed.

FIG. 10 is a flowchart illustrating an operation example of a visualization device according to Explanatory Example 2.

FIG. 11 is an explanatory diagram illustrating a hardware configuration example of a computer.

### EXAMPLE EMBODIMENT

Hereinafter, example embodiments of a visualization method, a visualization device, a program, and a non-transitory recording medium for recording a program according to the present disclosure will be described in detail with reference to the drawings. The present example embodiment does not limit the disclosed technology.

First, the optimization problem is to obtain a solution that maximizes or minimizes a certain objective function under given constraints. In each example embodiment, the objective function has a viewpoint of evaluating the goodness of the optimization target as a feature quantity. The weighting of the feature quantity may be set based on experience or the like, or may be obtained by learning based on the decision-making history of the subject.

For example, when optimal shift creation is performed, “labor cost”, “degree of reflection of request for leave”, and the like can be cited as the feature quantity of the objective function. Weighting is performed on these feature quantities. In such a case, the creator of the shift intends to “set up a shift to keep labor costs as low as possible” and “set up a shift in such a way that the leave request can be heard as much as possible”.

Examples of the subject include a skilled person. There may be a plurality of subjects. Constraints are an item that needs to be followed at the time of decision-making. The feature quantity, that is, the viewpoint is an item considered at the time of decision-making.

### First Example Embodiment

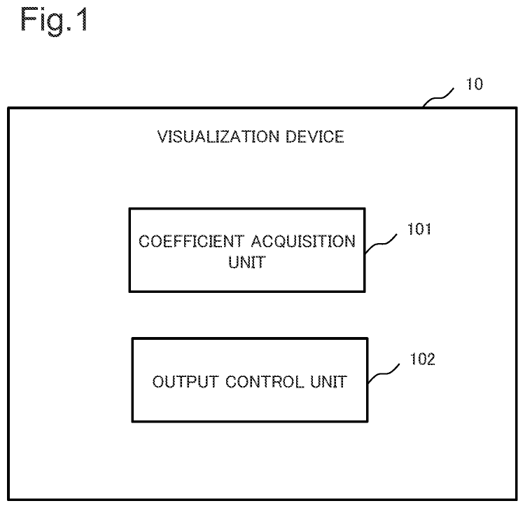

First, in a first example embodiment, the basic function of a visualization device will be described. FIG. 1 is a block diagram illustrating a configuration example of a visualization device according to the first example embodiment. For example, the user performs optimization by using the learned objective function, but needs to select an objective function suitable for his/her intention. Therefore, a visualization device 10 visualizes the intention of the subject in the objective function. In FIG. 1, the visualization device 10 includes a coefficient acquisition unit 101 and an output control unit 102.

The coefficient acquisition unit 101 acquires, for each of a plurality of different objective functions, a weighting coefficient for each of a plurality of feature quantities common to the plurality of objective functions. The plurality of feature quantities may be common to the plurality of objective functions. Alternatively, at least some of the plurality of feature quantities may be feature quantities present in some of the plurality of objective functions. The plurality of objective functions are criteria for deriving an optimal solution for the same action. For example, the plurality of objective functions may be obtained by learning based on a plurality of different decision-making histories. This learning is, for example, inverse reinforcement learning. For example, each subject (for example, a skilled person) may have a decision-making history, or the same subject may have decision-making histories at different timings such as different time zones.

The action herein includes, for example, work. In the following description, there is a case where the description is made using work. For example, the action may be a work of determining some combination such as a work of determining the order of tasks or the like, a work of scheduling such as assigning a shift, a work of matching such as assigning a task, and allocation of resources for determining a combination of dishes within an upper limit of calories, and is not particularly limited.

Here, it is assumed that the weighting coefficient is assigned to each feature quantity. The weighting coefficient of each feature quantity indicates the degree of influence of each feature quantity on the solution of each objective function. That is, the feature quantity regarded as important is different for each objective function, and the weighting coefficient indicates, for example, which feature quantity is regarded as important in the objective function. In the present example embodiment, it is assumed that the larger the weighting coefficient, the more important the feature quantity is in the objective function. For example, in the case of a feature quantity that is present in some objective functions among the plurality of objective functions but is not present in other objective functions among the plurality of objective functions, the weighting coefficient of the feature quantity in the other objective functions may be 0, that is, the feature quantity may not be regarded as important.

The output control unit 102 outputs, for each of the plurality of objective functions, a weighting coefficient for each of the plurality of feature quantities in a comparable manner. The output format of the output control unit 102 is not particularly limited. The output control unit 102 may display each weighting coefficient on a display device, or may output the weighting coefficient to a sound output device by audio. The output device such as a display device or a sound output device may be included in the visualization device 10, or may be provided in a device connected to the visualization device 10 through a communication network or the like.

For example, the output control unit 102 may output the weighting coefficients of the plurality of feature quantities side by side for each of the plurality of objective functions. The order of arrangement of the weighting coefficients is not particularly limited. For example, the output control unit 102 may arrange the weighting coefficients in a predetermined order or may arrange the weighting coefficients in a designated order. As will be described in detail in a second example embodiment, the output control unit 102 may output weighting coefficients side by side in such a way that feature quantities in a trade-off relationship are adjacent to each other.

For example, the output control unit 102 may graphically output the weighting coefficient of each of the plurality of feature quantities. The type of graph is not particularly limited, such as a bar graph, a pie graph, or a band graph. The order of arrangement of the weighting coefficients in graphing is not particularly limited. For example, the order of arrangement of the weighting coefficients in graphing may be the above-described order.

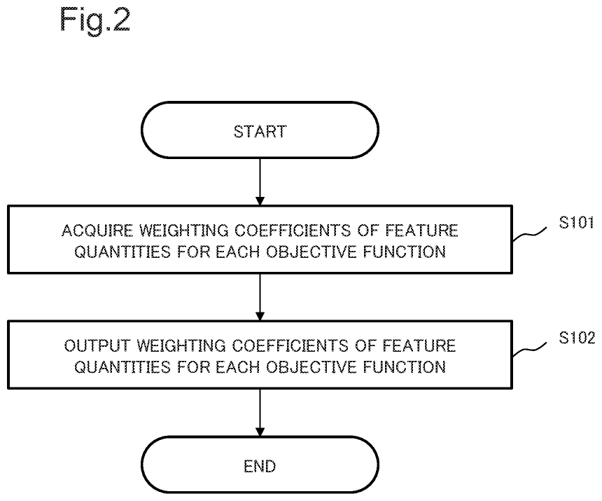

FIG. 2 is a flowchart illustrating an operation example of the visualization device 10 according to the first example embodiment. The visualization device 10 acquires a weighting coefficient of each feature quantity for each objective function (step S101). The visualization device 10 outputs the weighting coefficients of the respective feature quantities for each objective function in a comparable manner (step S102).

As described above, in the first example embodiment, the visualization device 10 acquires the weighting coefficient of each feature quantity for each objective function, and outputs the acquired weighting coefficient in a comparable manner. As a result, what kind of intention the learning or setting is based on is visualized. Therefore, it is possible to improve ease of checking the objective function. That is, the intention of each objective function is displayed in a more easily understandable format for the user. As a result, for example, the user can obtain a sense of understanding as to what intention the solution obtained by the objective function has been obtained. At least some of the plurality of objective functions may be objective functions obtained by multi-objective optimization.

The first example embodiment is not limited to the example described above, and various modifications can be made. Each functional unit may be implemented by one device. For example, each functional unit may be implemented by one device such as one server or one terminal device operable by the user. Alternatively, each functional unit may be implemented as a system using a plurality of devices.

### Second Example Embodiment

Next, a second example embodiment will be described in detail with reference to the drawings. Hereinafter, description of contents overlapping the above description will be omitted to the extent that the description of the second example embodiment is not unclear.

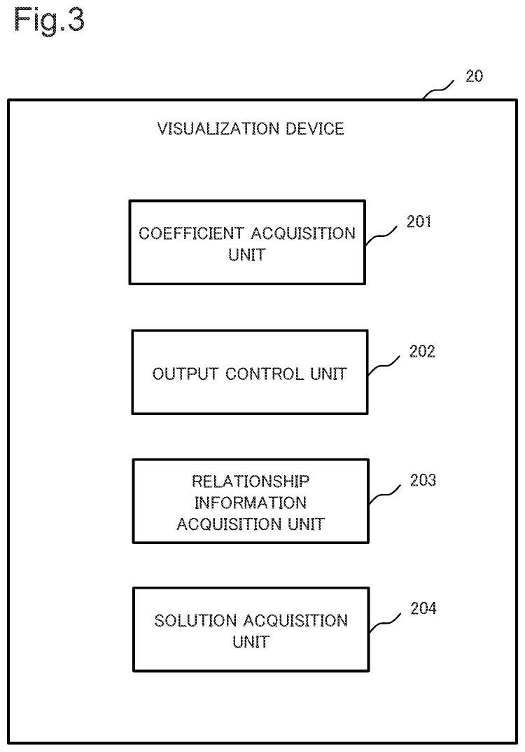

FIG. 3 is a block diagram illustrating a configuration example of a visualization device according to the second example embodiment. A visualization device 20 includes a coefficient acquisition unit 201, an output control unit 202, a relationship information acquisition unit 203, and a solution acquisition unit 204. In the second example embodiment, the relationship information acquisition unit 203 and the solution acquisition unit 204 are added to the first example embodiment. The coefficient acquisition unit 201 and the output control unit 202 have the basic functions of the coefficient acquisition unit 101 and the output control unit 102 described in the first example embodiment, respectively. For example, the visualization device 20 may have information of a plurality of objective functions.

As described in the first example embodiment, the coefficient acquisition unit 201 acquires the weighting coefficient for each of the plurality of feature quantities for each objective function.

As described in the first example embodiment, the output control unit 202 outputs the acquired weighting coefficient for each of the plurality of objective functions in a comparable manner.

In order to describe the relationship information acquisition unit 203, the solution acquisition unit 204, and the output control unit 202 in more detail, Explanatory Example 1 and Explanatory Example 2 will be used.

### Explanatory Example 1

In Explanatory Example 1, an example in which the weighting coefficient of the feature quantity is graphically displayed will be described. Here, an example in which a graph of weighting coefficients is displayed will be described using Example 1 and Example 2.

### Example 1

Example 1 is an example in which weighting coefficients of feature quantities in a trade-off relationship are displayed adjacent to each other for each objective function. For example, it is assumed that an objective function of an optimization problem that solves a shift scheduling work of a store clerk is learned in store operations. When it is preferable that the labor cost is low but it is desired to secure a large number of clerks, there is a trade-off relationship between the feature quantity related to the labor cost and the feature quantity related to securing the number of people.

The relationship information acquisition unit 203 acquires relationship information indicating feature quantities in a trade-off relationship among a plurality of feature quantities. Whether at least two feature quantities are in a trade-off relationship may be determined manually, or may be determined according to whether predetermined conditions are satisfied. That is, the relationship information may be created manually, or may be created according to whether predetermined conditions are satisfied.

Based on the relationship information, the output control unit 202 outputs the weighting coefficients of the plurality of feature quantities side by side in such a way that the weighting coefficients of the feature quantities in a trade-off relationship among the plurality of feature quantities are adjacent to each other for each of the plurality of objective functions. For example, the output control unit 202 may graph the weighting coefficients of the plurality of feature quantities in such a way that the weighting coefficients of the feature quantities in a trade-off relationship are adjacent to each other.

The output control unit 202 may output information indicating that there is a trade-off relationship between a plurality of different feature quantities. For example, the information indicating that there is a trade-off relationship may be a symbol such as an arrow, a number, or a character, or may be a color.

For example, when a difference between the weighting coefficients of feature quantities in a trade-off relationship is equal to or greater than a threshold value, the output control unit 202 may output information indicating that the difference is equal to or greater than the threshold value.

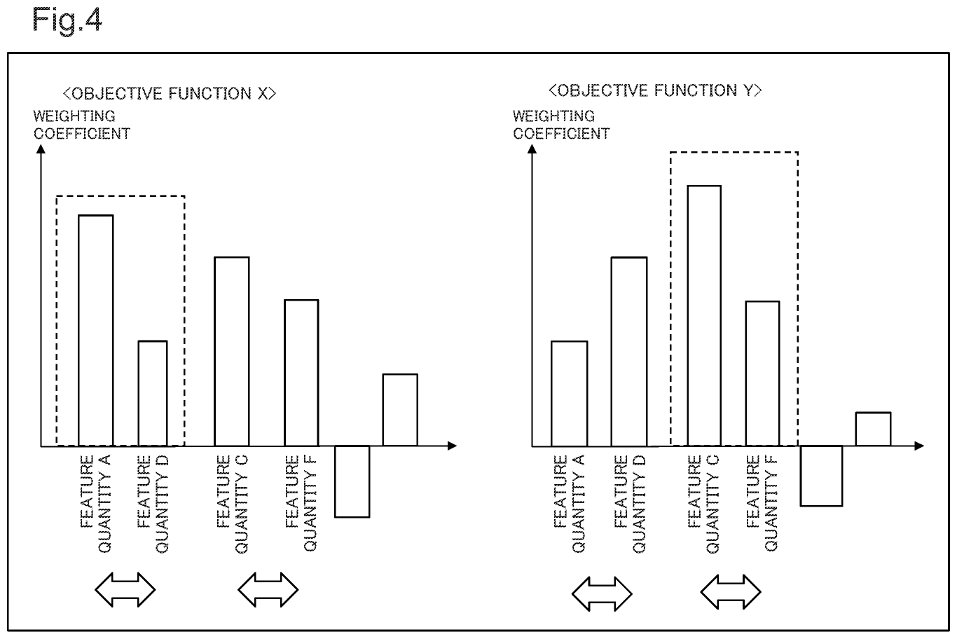

FIG. 4 is an explanatory diagram illustrating an example of a screen on which weighting coefficients of feature quantities in a trade-off relationship are displayed adjacent to each other. FIG. 4 illustrates a graph in which the weighting coefficients of feature quantities can be compared with each other for each objective function. In each graph, the horizontal axis indicates each feature quantity, and the vertical axis indicates a weighting coefficient.

For example, in FIG. 4, arrows in both directions are information indicating that the feature quantities are in a trade-off relationship. In FIG. 4, a feature quantity A and a feature quantity D are in a trade-off relationship. In FIG. 4, a feature quantity C and a feature quantity F are in a trade-off relationship.

For example, a case where the feature quantity A is a labor cost and the feature quantity D is for securing the number of people will be described as an example. In FIG. 4, in an objective function X, the weighting coefficient of the feature quantity A is smaller than the weighting coefficient of the feature quantity D. On the other hand, in FIG. 4, in an objective function Y, the weighting coefficient of the feature quantity D is smaller than the weighting coefficient of the feature quantity A. Therefore, for example, the user who wants to place more importance on the labor cost may select the objective function X, and the user who wants to place more importance on securing the number of people may select the objective function Y.

For example, when a difference between the weighting coefficients of a plurality of different feature quantities in a trade-off relationship is equal to or greater than a threshold value, the output control unit 202 outputs information indicating that the difference is equal to or greater than the threshold value. The threshold may be determined in advance, and is not particularly limited. For example, when the difference is equal to or greater than the threshold value, the output control unit 202 may highlight a plurality of different feature quantities in a trade-off relationship. In FIG. 4, information indicating that the difference is equal to or greater than the threshold is indicated by a dotted line box. For example, in FIG. 4, in the graph of the objective function X, since the difference between the weighting coefficient of the feature quantity A and the weighting coefficient of the feature quantity D is equal to or greater than the threshold value, the weighting coefficient of the feature quantity A and the weighting coefficient of the feature quantity D are highlighted by being surrounded by a dotted line. For example, in the graph of the objective function Y, since the difference between the weighting coefficient of the feature quantity C and the weighting coefficient of the feature quantity F is equal to or greater than the threshold value, the weighting coefficient of the feature quantity C and the weighting coefficient of the feature quantity F are highlighted by being surrounded by a dotted line.

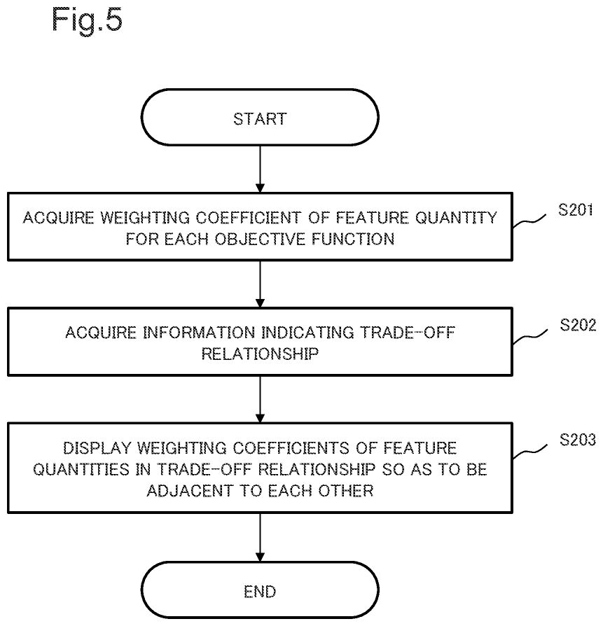

FIG. 5 is a flowchart illustrating Operation Example 1 of the visualization device 20 according to Explanatory Example 1. The visualization device 20 acquires a weighting coefficient of a feature quantity for each objective function (step S201). Then, the relationship information acquisition unit 203 acquires relationship information indicating feature quantities in a trade-off relationship among a plurality of feature quantities (step S202). Then, the output control unit 202 displays the weighting coefficients of the feature quantities in the trade-off relationship on the display device in such a way as to be adjacent to each other for each objective function (step S203).

### Example 2

Example 2 describes an example in which a difference between weighting coefficients for each of a plurality of feature quantities in a plurality of objective functions is displayed. Example 2 may be combined with Example 1.

For example, the output control unit 202 outputs a difference between the weighting coefficients for each of the plurality of feature quantities in the plurality of objective functions. To explain using the feature quantity A as an example when there are the objective function X and the objective function Y, the output control unit 202 outputs a difference between the weighting coefficient of the feature quantity A of the objective function X and the weighting coefficient of the feature quantity A of the objective function Y.

Since there are a plurality of feature quantities, the output control unit 202 may output differences between the weighting coefficients of the plurality of feature quantities side by side. In combination with Example 1, the output control unit 202 may display the differences between the weighting coefficients of the feature quantities in a trade-off relationship side by side in such a way as to be adjacent to each other. For example, the output control unit 202 may graphically output the difference between the weighting coefficients of the plurality of feature quantities. In combination with Example 1, the output control unit 202 may output a graph in such a way that the differences between the weighting coefficients of feature quantities in a trade-off relationship are adjacent to each other.

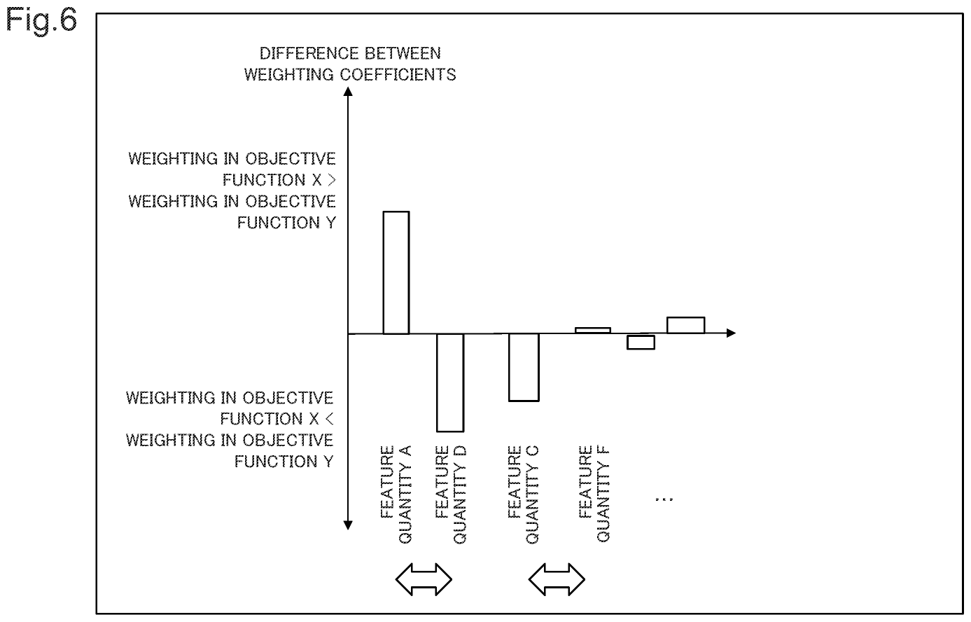

FIG. 6 is an example of a screen on which differences between weighting coefficients in a plurality of objective functions are displayed. FIG. 6 illustrates a graph in which differences between the weighting coefficients of feature quantities in a plurality of objective functions can be compared with each other. In each graph, the horizontal axis indicates each feature quantity, and the vertical axis indicates a difference between weighting coefficients.

FIG. 6 illustrates a difference between the feature quantities in the objective function X and the objective function Y. The vertical axis is, for example, a value (difference) obtained by subtracting the weighting coefficient of the objective function Y from the weighting coefficient of the objective function X. In FIG. 6, the larger the weighting coefficient in the objective function X is than the weighting coefficient in the objective function Y, the more the difference becomes a positive value. The smaller the weighting coefficient in the objective function X is than the weighting coefficient in the objective function Y, the more the difference becomes a negative value.

In FIG. 6, for example, as in FIG. 4, the output control unit 202 may output differences between feature quantities in a trade-off relationship to be adjacent to each other. In FIG. 6, arrows in both directions are information indicating that the feature quantities are in a trade-off relationship. In FIG. 6, a feature quantity A and a feature quantity D are in a trade-off relationship. In FIG. 6, a feature quantity C and a feature quantity F are in a trade-off relationship.

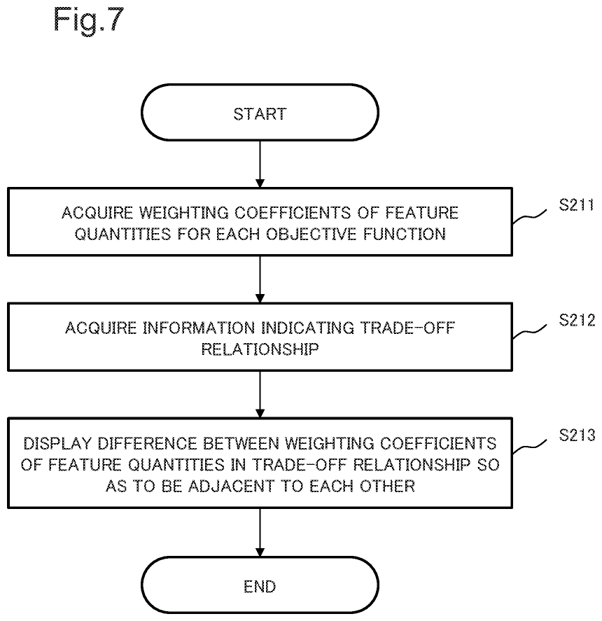

FIG. 7 is a flowchart illustrating Operation Example 2 of the visualization device 20 according to Explanatory Example 1. The coefficient acquisition unit 201 acquires a weighting coefficient of a feature quantity for each objective function (step S211). Then, the relationship information acquisition unit 203 acquires relationship information indicating feature quantities in a trade-off relationship among a plurality of feature quantities (step S212). Then, the output control unit 202 displays the differences between the weighting coefficients of the feature quantities in the trade-off relationship side by side on the display device in such a way as to be adjacent to each other (step S213).

### Explanatory Example 2

In Explanatory Example 2, a weighting coefficient is further presented for each of the plurality of objective functions in a comparable manner, and a result when the optimization problem is actually solved using the objective function is presented for each objective function.

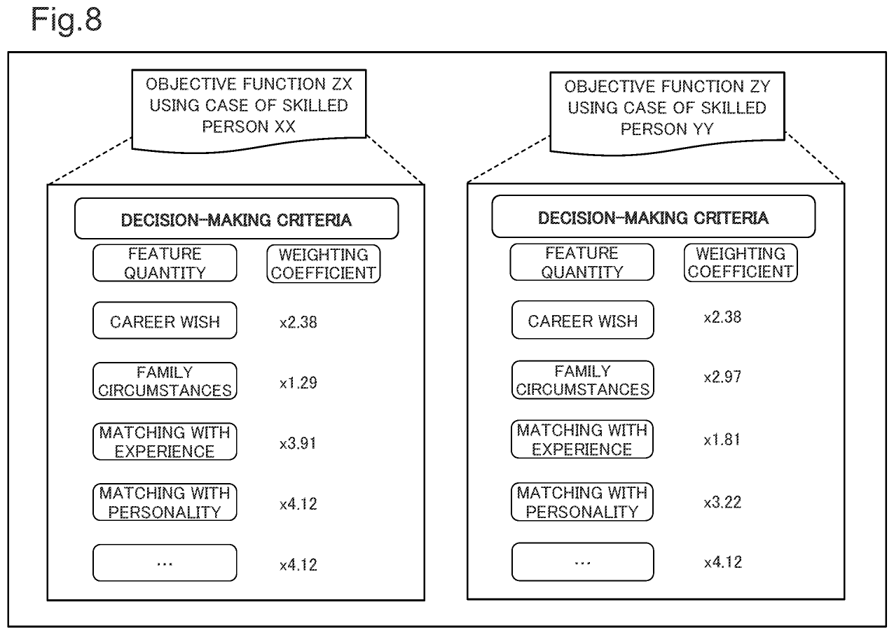

FIG. 8 is an explanatory diagram illustrating examples of an objective function and a weighting coefficient obtained by a learning case for each skilled person. In FIG. 8, the feature quantity of the objective function and the weighting coefficient of the feature quantity for optimizing the work of assigning the work are illustrated.

In FIG. 8, a case where each objective function is obtained by using skilled persons XX and YY as learning cases will be described as an example. An example in which the objective function ZX is obtained when the person XX is a learning case and the objective function ZY is obtained when the person YY is a learning case will be described.

For example, in FIG. 8, feature quantities include “matching with career wish”, “family circumstances”, “matching with experience”, and “matching with personality”, and the like. The objective function ZX and the objective function ZY have the same feature quantity, but have different weighting coefficients of the feature quantity. In FIG. 8, the objective function ZX has a lower value of the weighting coefficient of the feature quantity “family circumstances” and a higher value of the weighting coefficient of the feature quantity “matching with experience” than the objective function ZY. Therefore, for the objective function ZX, “matching with experience” is more important than for the objective function ZY. On the other hand, for the objective function ZY, “family circumstances” is more important than for the objective function ZX.

The solution acquisition unit 204 acquires, for each of the plurality of objective functions, a solution obtained based on the objective function to which information indicating a predetermined state is given. Here, the obtained solution will be described by taking the optimal solution as an example, but may be a feasible solution and is not particularly limited. The predetermined state may be, for example, a representative state. For example, the representative state may be, for example, a state designated by the user. The representative state may be a state in which the user is placed or a state created empirically by the user. The representative state is a state that can be determined differently by skilled persons. A specific state may be determined by optimization work.

Here, data used to calculate the feature quantity of the objective function is state data, and a typical state thereof is a predetermined state, for example, a representative state. By using the objective function and the representative state, an optimal solution in the representative state is derived. Therefore, data related to calculation of the feature quantity of the objective function is used as information indicating a predetermined state.

The information indicating the representative state may be sales performance data for each product. The information indicating the representative state may be data of a campaign such as a discount or a discount based on the sale of a combination of products. The information indicating the representative state may be environmental data regarding an environment such as weather, temperature, and humidity, or calendar data such as a day of the week, a holiday, and a summer vacation.

The information indicating the representative state may be event data such as a nearby event or a date and time of an event. The information indicating the representative state may be inventory data such as delivery and disposal. The information indicating the representative state may be persona data such as persona indicating the state of the person, such as the skill, experience, and desired career of the employee. The information indicating the representative state may be data such as a preference table of a shift. The information indicating the representative state may be prediction data such as a preference table of a shift.

For example, an example of the representative state when the environmental data is used as state data is illustrated. When the environmental data is “weather, temperature, humidity”, “the weather is sunny, the temperature is 30°, and the humidity is 20%” or the like is a representative state, and vector data indicating these values is information indicating the representative state.

For example, in the example of optimization of the order work, as the information indicating the representative state, environmental data, calendar data, event data, a sales prediction value, a current inventory amount, and a backyard allowance may be used. For example, in the example of optimization of work of assigning a job, persona data may be used as information indicating a representative state.

Here, in the objective function having a weighting coefficient as illustrated in FIG. 8, when calculating the “degree of matching with career wish”, data of “his or her own career wish” and “related career of the task” is used as information indicating the representative state.

Here, the desire for the career type of each of the persons AA and BBB and the degree of matching between the career type and the task will be described below. For example, it is assumed that the career types are from a to d. The desired career type is set to 1. When the task and the career type match, the degree of matching is set to 1.

Career type

| | a | b | c | d |
|---|---|---|---|---|
| Person AA | 0 | 1 | 0 | 0 |
| Person BB | 0 | 0 | 1 | 0 |
| task | 0 | 1 | 0 | 0 |

In such an example, the desire of the career type of the person AA is b, and the desire of the career type of the person BB is c. For example, the degree of matching between the career type a and the task is 0. The degree of matching between the career type b and the task is 1. The degree of matching between the career type c and the task is 0. The degree of matching between the career type d and the task is 0. In such a case, the degree of matching between the task and the career wish of the person AA is 1, and the degree of matching between the task and the career wish of the person BB is 0 or the like. In such a case, whether the task is finally assigned to the person AA or the task is assigned to the person BB in consideration of other feature quantities (for example, match with experience) differs depending on the weighting of which feature quantity is emphasized to what extent. In the present disclosure, since the decision making result as to whether to become the person AA or the person BB is displayed by the objective function, it is easy to check what each objective function emphasizes.

Therefore, as described above, it is desirable that state data related to the “degree of matching with career wish” as illustrated in FIG. 8 is used and state data having different optimization results depending on the objective function is selected as information indicating the representative state. For example, “for a task x for which someone needs to be assigned, the person AA who has no experience but matches the career wish and the person Mr. BB who has no career wish but matches the experience” are prepared as examples of information indicating a representative state. For example, if information indicating such a representative state is used, it is expected that the assignment result, which is an optimization result, will be different between an objective function emphasizing experience and an objective function emphasizing the degree of matching with the career wish.

Specifically, for example, the solution acquisition unit 204 derives a solution by giving information indicating a predetermined state for each of the plurality of objective functions. As a result, the solution acquisition unit 204 can acquire a solution. Alternatively, for example, the solution acquisition unit 204 may acquire, for each of the plurality of objective functions, a solution derived by another device from the another device.

The output control unit 202 outputs a weighting coefficient for each of the plurality of objective functions in a comparable manner and outputs the acquired solution. As a result, it is possible to check the influence of the weighting coefficient on the solution while viewing the weighting coefficient and the solution.

The solution acquisition unit 204 may give information indicating each of a plurality of different states to each of a plurality of objective functions and acquire a solution obtained based on the objective function. For example, in the case of a persona, the solution acquisition unit 204 gives each persona data to each of a plurality of objective functions and acquires a solution obtained based on the objective function. Then, for each of the plurality of states, the output control unit 202 outputs the solution acquired for each of the plurality of objective functions.

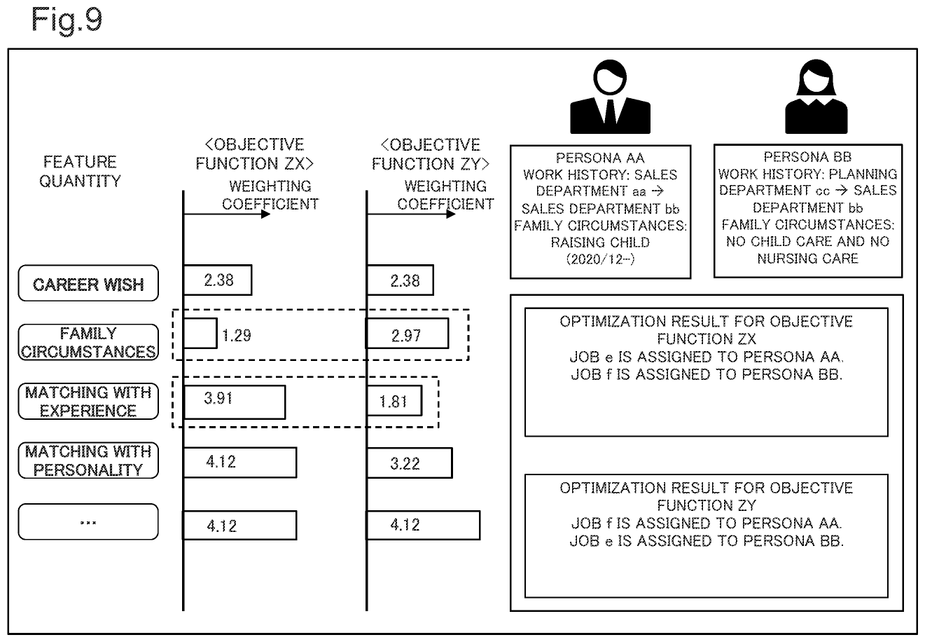

FIG. 9 is an explanatory diagram illustrating an example of a screen on which a comparison of weighting coefficients for each objective function and an optimization result of a job assignment for each persona are displayed. Here, for example, it is assumed that there is a decision making (optimization problem) to assign a job e and a job f to two employees AA and BB. One person is assigned to each job. It is assumed that the job e is a job that desirably has experience in the sales department aa but has a high burden.

In FIG. 9, a weighting coefficient of the feature quantity is displayed for each of the objective function ZX and the objective function ZY indicating which persona (employee) is assigned with which job.

In FIG. 9, as personae corresponding to employees, a persona AA and a persona BB are representative states. In the persona AA, the work history is sales experience in the sales department aa and sales experience in the sales department bb, and the family circumstances are that the persona AA has been raising a child since December 2020. On the other hand, in the persona BB, the work history is planning experience in the planning department cc and sales experience in the sales department bb, and the family circumstances are no child care and no nursing care.

In FIG. 9, an optimization result that is a solution obtained from each of the objective function ZX and the objective function ZY of which persona (employee) is assigned with which job is displayed.

If the difference between the weighting coefficients in each feature quantity is equal to or greater than a threshold value, the output control unit 202 may highlight the weighting coefficients. A method of highlighting is not particularly limited. In FIG. 9, since there is a large difference in the feature quantity “family circumstances” between the objective function ZX and the objective function ZY, the two weighting coefficients are highlighted by being surrounded by a dotted frame. Since there is a large difference in the feature quantity “matching with experience” between the objective function ZX and the objective function ZY, the two weighting coefficients are highlighted by being surrounded by a dotted frame.

In FIG. 9, the objective function ZX has a lower value of the weighting coefficient of the feature quantity “family circumstances” and a higher value of the weighting coefficient of the feature quantity “matching with experience” than the objective function ZY. Therefore, for the objective function ZX, “matching with experience” is more important than for the objective function ZY. On the other hand, for the objective function ZY, “family circumstances” is more important than for the objective function ZX.

Since the job e is a job that it is desirable to have experience in the sales department aa, the job e is assigned to the persona AA and the job f is assigned to the persona BB in the optimization result for the objective function ZX in which “matching with experience” is emphasized.

Since the job e is a high-load job, the job f is assigned to the persona AA and the job e is assigned to the persona BB in the optimization result for the objective function ZY in which “family circumstances” are emphasized.

Although not illustrated, the output control unit 202 may highlight the solutions when a difference between the solutions due to a difference in a state such as a persona is a specific difference or more.

Although the output control unit 202 displays all the pieces of information on one screen in FIG. 9, the output control unit 202 may display the information on a plurality of switchable screens.

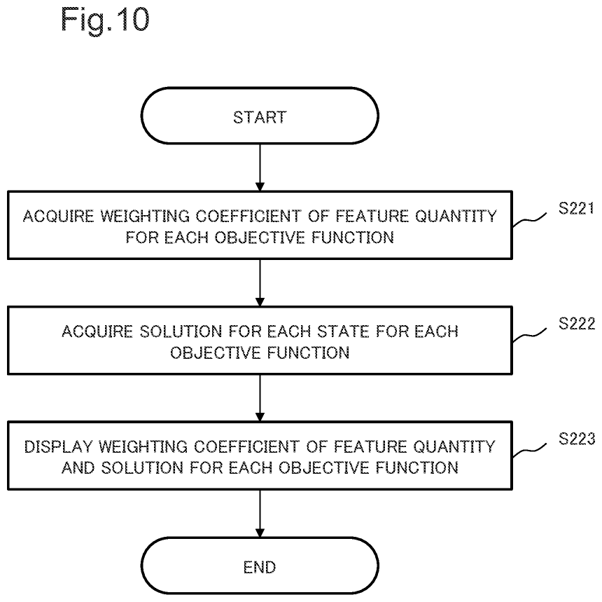

FIG. 10 is a flowchart illustrating an operation example of the visualization device 20 according to Explanatory Example 2. The coefficient acquisition unit 201 acquires a weighting coefficient of a feature quantity for each objective function (step S221). Then, the solution acquisition unit 204 acquires a solution for each state for each objective function (step S222). Then, the output control unit 202 displays the weighting coefficient of the feature quantity and the solution on the display device for each objective function (step S223).

As described above, in the second example embodiment, the visualization device 20 outputs weighting coefficients side by side in such a way that the weighting coefficients of feature quantities in a trade-off relationship among a plurality of feature quantities are adjacent to each other. As a result, it is possible to more easily check which feature quantity among the plurality of feature quantities in a trade-off relationship in each objective function has a stronger influence.

When the difference between the weighting coefficients of the feature quantities in a trade-off relationship is equal to or greater than the threshold value, the visualization device 20 outputs information indicating that the difference is equal to or greater than the threshold value. As a result, it is possible to easily check the influence of intention having a trade-off relationship.

The visualization device 20 outputs information indicating that there is a trade-off relationship. As a result, it is possible to easily grasp which feature quantities are in a trade-off relationship among the plurality of feature quantities.

The visualization device 20 outputs a difference between the weighting coefficients for each of the plurality of feature quantities in the plurality of objective functions. As a result, it is possible to easily check the difference in the influence of each intention between different objective functions.

The visualization device 20 outputs, for each of the plurality of objective functions, a weighting coefficient for each of the plurality of feature quantities and a solution obtained based on the objective function to which information indicating a predetermined state is given. As a result, it is possible to easily check the influence of the difference in the weighting coefficient on the solution.

The visualization device 20 may output, for each objective function, a solution obtained based on the objective function for each of the plurality of states. As a result, it is possible to easily check the influence on the solution due to the difference in the weighting coefficient in a plurality of different states.

This is the end of the description of each example embodiment. The example embodiments may be used in combination. For example, in each example embodiment, the visualization device may include each functional unit and a part of information. For example, the visualization device 20 according to the second example embodiment may include the coefficient acquisition unit 201, the output control unit 202, and the relationship information acquisition unit 203. For example, the visualization device 20 according to the second example embodiment may include the coefficient acquisition unit 201, the output control unit 202, and the solution acquisition unit 204.

Each example embodiment is not limited to the above-described examples, and various modifications can be made. The configuration of the visualization device in each example embodiment is not particularly limited. Each functional unit described in the example embodiment may be implemented by one device (visualization device) or may be implemented as a visualization system by a plurality of different devices.

A button, an information display field, an input field, and the like (not illustrated) may be added to each screen. In each screen, the position, color, and size of each item such as a button, an input field, and a display field are not particularly limited. The background color of the screen and the like may be changed.

For example, in each example embodiment, when the display device as an output device is provided by a device different from the visualization devices 10 and 20, the processing of generating information or the like of the screen to be displayed on the display device may be performed by the output control units 102 and 202, or may be performed by a device including the display device.

### (Computer)

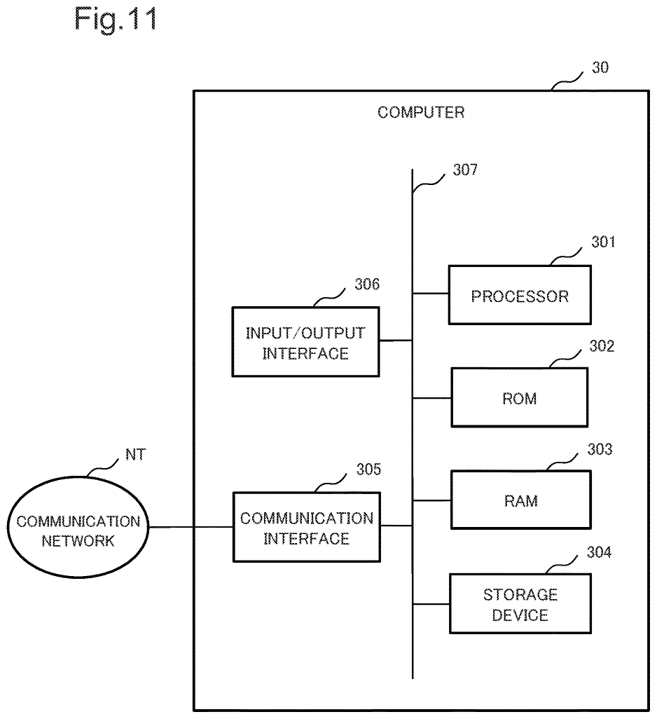

Next, a hardware configuration example when the visualization device described in each example embodiment is implemented by a computer will be described. FIG. 11 is an explanatory diagram illustrating a hardware configuration example of a computer. For example, some or all of the devices can be implemented by using any combination of the computer 30 and the program illustrated in FIG. 11, for example.

The computer 30 includes, for example, a processor 301, a read only memory (ROM) 302, a random access memory (RAM) 303, a storage device 304, a communication interface 305, and an input/output interface 306. The components are connected to each other through a bus 307. The number of components is not particularly limited, and each component is one or more.

The processor 301 controls the entire computer 30. Examples of the processor 301 include a central processing unit (CPU), a digital signal processor (DSP), and a graphics processing unit (GPU). The number of processors 301 may be plural. The computer 30 includes the ROM 302, the RAM 303, the storage device 304, and the like as storage units. Examples of the storage device 304 include a semiconductor memory such as a flash memory, a hard disk drive (HDD), and a solid state drive (SSD). For example, the storage device 304 stores an operating system (OS) program, an application program, a program according to each example embodiment, and the like. Alternatively, the ROM 302 stores an application program, a program according to each example embodiment, and the like. Then, the RAM 303 is used as a work area of the processor 301.

The processor 301 loads a program stored in the storage device 304, the ROM 302, or the like. Then, the processor 301 executes each processing (each processing instruction) coded in the program. The processor 301 may download various programs through the communication network NT. The processor 301 functions as a part or entirety of the computer 30. Then, the processor 301 may execute processing or instructions in the illustrated flowchart based on the program.

The communication interface 305 is connected to the communication network NT, such as a local area network (LAN) or a wide area network (WAN), through a wireless or wired communication line. The communication network NT may include a plurality of communication networks. As a result, the computer 30 is connected to an external device or an external computer 30 through the communication network NT. The communication interface 305 manages an interface between the communication network NT and the inside of the computer 30. Then, the communication interface 305 controls input and output of data from the external device or the external computer 30.

The input/output interface 306 is connected to at least one of an input device, an output device, and an input/output device. The connection method may be wireless or wired. Examples of the input device include a keyboard, a mouse, and a microphone. Examples of the output device include a display device, a lighting device, and a speaker that is a sound output device that outputs a sound. Examples of the input/output device include a touch panel display. The input device, the output device, the input/output device, and the like may be built in the computer 30 or may be externally attached.

The hardware configuration of the computer 30 is an example. The computer 30 may have some components illustrated in FIG. 11. The computer 30 may have components other than those illustrated in FIG. 11. For example, the computer 30 may include a drive device or the like. Then, the processor 301 may read a program or data stored in a recording medium installed in a drive device or the like into the RAM 303. Examples of the non-transitory tangible recording medium include an optical disk, a flexible disk, a magnetic optical disk, and a universal serial bus (USB) memory. As described above, for example, the computer 30 may include an input device such as a keyboard and a mouse. The computer 30 may include an output device such as a display. The computer 30 may include an input device, an output device, and an input/output device. The computer 30 may include various sensors (not illustrated). The number of feasible solutions is not particularly limited.

This is the end of the description of the hardware configuration of the visualization device. There are various modifications of the method for implementing the visualization device. For example, the visualization device may be implemented by any combination of a computer and a program different for each component. A plurality of components included in the visualization device may be implemented by any combination of one computer and a program.

Some or all of the components of each device such as the visualization device may be implemented by an application specific circuit. A part or entirety of each device may be implemented by a general-purpose circuit including a processor such as a field programmable gate array (FPGA). A part or entirety of each device may be implemented by a combination of an application specific circuit, a general-purpose circuit, and the like. These circuits may be a single integrated circuit. Alternatively, these circuits may be divided into a plurality of integrated circuits. The plurality of integrated circuits may be configured by being connected to each other through a bus or the like.

When a part or entirety of each component of each device is implemented by a plurality of computers, circuits, and the like, the plurality of computers, circuits, and the like may be arranged in a centralized manner or in a distributed manner.

The visualization method described in each example embodiment is implemented by a computer such as a visualization device. The visualization method is implemented by a computer such as a visualization device executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. The program may be distributed through the communication network NT.

The function of each component of each device such as the visualization device in each example embodiment described above may be implemented by hardware like a computer. Alternatively, each component may be implemented by a computer or firmware based on program control.

While the present disclosure has been particularly shown and described with reference to exemplary embodiments thereof, the present disclosure is not limited to these embodiments. The configuration and details of each present disclosure may include example embodiments to which various changes that can be grasped by those of ordinary skill in the art without departing from the spirit and the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A visualization method,
including:
acquiring, for each of a plurality of different objective functions, a weighting coefficient for each of a plurality of feature quantities; and
outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

### (Supplementary Note 2)

The visualization method described in Supplementary Note 1, further including:
acquiring relationship information indicating feature quantities in a trade-off relationship among the plurality of feature quantities,
wherein, in the outputting, based on the acquired relationship information, the weighting coefficients for the plurality of feature quantities are output side by side, for each of the plurality of objective functions, in such a way that weighting coefficients of feature quantities in the trade-off relationship among the plurality of feature quantities are adjacent to each other.

### (Supplementary Note 3)

The visualization method described in Supplementary Note 2,
wherein, in the outputting, when a difference between the weighting coefficients of the feature quantities in the trade-off relationship is equal to or greater than a threshold value, information indicating that the difference is equal to or greater than the threshold value is output.

### (Supplementary Note 4)

The visualization method described in Supplementary Note 2 or 3,
wherein, in the outputting, information indicating that there is the trade-off relationship is output.

### (Supplementary Note 5)

The visualization method described in any one of Supplementary Notes 1 to 4,
wherein, in the outputting, a difference between the weighting coefficients for the plurality of feature quantities in the plurality of objective functions is output.

### (Supplementary Note 6)

The visualization method described in Supplementary Note 1,
further including:
acquiring, for each of the plurality of objective functions, a solution obtained based on the objective function to which information indicating a predetermined state is given,
wherein, in the outputting, for each of the plurality of objective functions, the weighting coefficients are output in a comparable manner and the acquired solution is output.

### (Supplementary Note 7)

The visualization method described in Supplementary Note 6,
wherein, in the acquisition of the solution, for each of a plurality of states, a solution obtained based on the objective function to which information indicating the state is given is acquired for each of the plurality of objective functions, and
in the outputting, the solution acquired for each of the plurality of objective functions is output for each of the plurality of states.

### (Supplementary Note 8)

The visualization method described in any one of Supplementary Notes 1 to 7,
wherein each of the plurality of objective functions is an objective function generated by inverse reinforcement learning.

### (Supplementary Note 9)

A visualization device,
including:
a coefficient acquisition means for acquiring, for each of a plurality of different objective functions, a weighting coefficient for each of a plurality of feature quantities; and
an output control means for outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

### (Supplementary Note 10)

The visualization device described in Supplementary Note 9,
further including:
a relationship information acquisition means for acquiring relationship information indicating feature quantities in a trade-off relationship among the plurality of feature quantities,
wherein, based on the acquired relationship information, the output control means outputs, for each of the plurality of objective functions, the weighting coefficients for the plurality of feature quantities side by side in such a way that weighting coefficients of feature quantities in the trade-off relationship among the plurality of feature quantities are adjacent to each other.

### (Supplementary Note 11)

The visualization device described in Supplementary Note 9,
further including:
a solution acquisition means for acquiring, for each of the plurality of objective functions, a solution obtained based on the objective function to which information indicating a predetermined state is given,
wherein, for each of the plurality of objective functions, the output control means outputs the weighting coefficients in a comparable manner and outputs the acquired solution.

### (Supplementary Note 12)

The visualization device described in any one of Supplementary Notes 9 to 11,
wherein each of the plurality of objective functions is an objective function generated by inverse reinforcement learning.

### (Supplementary Note 13)

A computer-readable non-transitory recording medium that records a program causing
a computer
to execute processing for:
acquiring, for each of a plurality of different objective functions, a weighting coefficient for each of a plurality of feature quantities; and
outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

### (Supplementary Note 14)

The recording medium described in Supplementary Note 13,
wherein each of the plurality of objective functions is an objective function generated by inverse reinforcement learning.

### (Supplementary Note 15)

The recording medium described in Supplementary Note 13 or 14,
wherein the computer
is caused to execute processing for
acquiring relationship information indicating feature quantities in a trade-off relationship among the plurality of feature quantities, and
in the processing for outputting, based on the acquired relationship information, the weighting coefficients for the plurality of feature quantities are output side by side, for each of the plurality of objective functions, in such a way that weighting coefficients of feature quantities in the trade-off relationship among the plurality of feature quantities are adjacent to each other.

### (Supplementary Note 16)

The recording medium described in Supplementary Note 13 or 14,
wherein the computer
is caused to execute processing for
acquiring, for each of the plurality of objective functions, a solution obtained based on the objective function to which information indicating a predetermined state is given, and
in the processing for outputting, for each of the plurality of objective functions, the weighting coefficients are output in a comparable manner and the acquired solution is output.

### (Supplementary Note 17)

A program causing
a computer
to execute processing for:
acquiring, for each of a plurality of different objective functions, a weighting coefficient for each of a plurality of feature quantities; and
outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

### (Supplementary Note 18)

The program described in Supplementary Note 17,
wherein each of the plurality of objective functions is an objective function generated by inverse reinforcement learning.

### REFERENCE SIGNS LIST

10, 20 visualization device
30 computer
101, 201 coefficient acquisition unit
102, 202 output control unit
203 relationship information acquisition unit
204 solution acquisition unit
301 processor
302 ROM
303 RAM
304 storage device
305 communication interface
306 input/output interface
307 bus
NT communication network
A, C, D, F feature quantity
AA, BB persona
X, Y, ZX, ZY objective function

What is claimed is:

1. A visualization method, implemented by a computer,
comprising:
acquiring, for each of a plurality of different objective functions, a weighting coefficient for each of a plurality of feature quantities; and
outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

2. The visualization method according to claim 1,
further comprising
acquiring relationship information indicating feature quantities in a trade-off relationship among the plurality of feature quantities,
wherein, in the outputting, based on the acquired relationship information, the weighting coefficients for the plurality of feature quantities are output side by side, for each of the plurality of objective functions, in such a way that weighting coefficients of feature quantities in the trade-off relationship among the plurality of feature quantities are adjacent to each other.

3. The visualization method according to claim 2,
wherein, in the outputting, when a difference between the weighting coefficients of the feature quantities in the trade-off relationship is equal to or greater than a threshold value, information indicating that the difference is equal to or greater than the threshold value is output.

4. The visualization method according to claim 2,
wherein, in the outputting, information indicating that there is the trade-off relationship is output.

5. The visualization method according to claim 1,
wherein, in the outputting, a difference between the weighting coefficients for the plurality of feature quantities in the plurality of objective functions is output.

6. The visualization method according to claim 1,
further comprising
acquiring, for each of the plurality of objective functions, a solution obtained based on the objective function to which information indicating a predetermined state is given,
wherein, in the outputting, for each of the plurality of objective functions, the weighting coefficients are output in a comparable manner and the acquired solution is output.

7. The visualization method according to claim 6,
wherein, in the acquisition of the solution, for each of a plurality of states, a solution obtained based on the objective function to which information indicating the state is given is acquired for each of the plurality of objective functions, and
in the outputting, the solution acquired for each of the plurality of objective functions is output for each of the plurality of states.

8. The visualization method according to claim 1,
wherein each of the plurality of objective functions is an objective function generated by inverse reinforcement learning.

9. A visualization device,
comprising:
a memory storing instructions; and
at least one processor configured to execute the instructions to:
acquire, for each of a plurality of different objective functions, a weighting coefficient for each of a plurality of feature quantities; and
output the weighting coefficients acquired for the plurality of objective functions in a comparable manner,
wherein the weighting coefficient for each of the plurality of feature quantities indicates a degree of influence of the feature quantity on a solution of each of the plurality of objective functions.

10. The visualization device according to claim 9, wherein the at least one processor is further configured to execute the instructions to:
acquire relationship information indicating feature quantities in a trade-off relationship among the plurality of feature quantities; and
based on the acquired relationship information, output, for each of the plurality of objective functions, the weighting coefficients for the plurality of feature quantities side by side in such a way that weighting coefficients of feature quantities in the trade-off relationship among the plurality of feature quantities are adjacent to each other.

11. The visualization device according to claim 9, wherein the at least one processor is further configured to execute the instructions to:
acquire, for each of the plurality of objective functions, a solution obtained based on the objective function to which information indicating a predetermined state is given; and
for each of the plurality of objective functions, output the weighting coefficients in a comparable manner and output the acquired solution.

12. The visualization device according to claim 9,
wherein each of the plurality of objective functions is an objective function generated by inverse reinforcement learning.

13. A non-transitory computer-readable recording medium that records a program causing
a computer
to execute processing for:
acquiring, for each of a plurality of different objective functions, a weighting coefficient for each of a plurality of feature quantities; and
outputting the weighting coefficients acquired for the plurality of objective functions in a comparable manner,
wherein the weighting coefficient for each of the plurality of feature quantities indicates a degree of influence of the feature quantity on a solution of each of the plurality of objective functions.

14. The recording medium according to claim 13,
wherein each of the plurality of objective functions is an objective function generated by inverse reinforcement learning.

15. The recording medium according to claim 13,
wherein the computer
is caused to execute processing for
acquiring relationship information indicating feature quantities in a trade-off relationship among the plurality of feature quantities, and
in the processing for outputting, based on the acquired relationship information, the weighting coefficients for the plurality of feature quantities are output side by side, for each of the plurality of objective functions, in such a way that weighting coefficients of feature quantities in the trade-off relationship among the plurality of feature quantities are adjacent to each other.

16. The recording medium according to claim 13,
wherein the computer
is caused to execute processing for
acquiring, for each of the plurality of objective functions, a solution obtained based on the objective function to which information indicating a predetermined state is given, and
in the processing for outputting, for each of the plurality of objective functions, the weighting coefficients are output in a comparable manner and the acquired solution is output.
